(19) United States
(12) Patent Application Publication
(10) Pub. No.: US 2008/0099151 A1
(43) Pub. Date: May 1, 2008

(54) Dispenser for magnetic adhesive tape

(76) Inventor: Yi-Ju Lee, Dou-Lio City (TW)

Correspondence Address: Hershkovitz & Associates, LLC, 2845 Duke Street, Alexandria, VA, 22314, US

(21) Appl. No.: 11/591,664

(22) Filed: Oct. 30, 2006

(51) Int. Cl. B32B 37/00

(52) U.S. Cl. 156/527

(57) ABSTRACT

A dispenser for magnetic adhesive tape has a housing and a blade base. The housing has a mounting post for mounting a roll of magnetic adhesive tape, an opening through which the magnetic adhesive passes and a retaining post having a longitudinal slot. The blade base is mounted on the retaining post and has a blade and a ring encircling the retaining post, defining a curved gap between the ring and the retaining post and having a free end extending beyond a distal end of the blade. With one hand, a user can easily pivot the dispenser at the free end to dispense a desired length of magnetic adhesive tape and then cut the magnetic adhesive tape with the blade. Furthermore, the free end of the ring protects a user's fingers from being injured by the blade.

### BACKGROUND OF THE INVENTION

1. Field of the Invention

The present invention relates to a dispenser for magnetic adhesive tape and more particularly to a dispenser for magnetic adhesive tape, which is safe and can be conveniently operated with one hand.

2. Description of Related Art

Magnetic adhesive tape has two sides. One side is adhesive and the other side is magnetic. After the adhesive side is bonded to an object, the object can be attached to a magnetic surface, e.g. a bulletin broad, a refrigerator or the like by magnetic attraction.

Magnetic adhesive tape is gradually becoming used more extensively. A dispenser holds a roll of magnetic adhesive tape such that the dispenser can be held and magnetic adhesive tape can be pulled from the dispenser and cut to a desired length with a blade on the dispenser.

However, a conventional dispenser for magnetic adhesive tape has several shortcomings including the following.

1. Lack of safety: The blade of the conventional dispenser protrudes from the dispenser and may injure a person's fingers.

2. Inconvenience: The dispenser requires the use of two hands. One hand holds the dispenser, and the other hand pulls a desired length of magnetic adhesive tape from the dispenser and cuts the magnetic adhesive tape, which is inconvenient and requires a person's fingers to contact adhesive on the tape.

### SUMMARY OF THE INVENTION

The primary objective of the present invention is to provide a dispenser for magnetic adhesive tape to improve safety and convenience during use.

The dispenser for magnetic adhesive tape in accordance with the present invention comprises a housing and a blade base.

The housing is hollow, rotatably holds a roll of magnetic adhesive tape and has an inner surface, an outer surface, a mounting post, an opening and a retaining post. The mounting post is formed on and protrudes perpendicularly from the inner surface of the housing and rotatably passes through a roll of magnetic adhesive tape to hold the roll of magnetic adhesive tape in the housing. The opening is formed through the outer surface of the housing such that magnetic adhesive tape on the roll can be drawn out through the opening. The retaining post, is tubular, is formed on and protrudes perpendicularly from the inner surface of the housing near the opening and has a longitudinal slot.

The blade base is mounted on the retaining post and has a base, a blade and a ring. The base is mounted securely in the retaining post and has a distal end and a blade recess. The distal end extends radially out of the longitudinal slot in the retaining post. The blade recess is formed in the distal end of the base. The blade is mounted in the blade recess and has a distal end. The distal end of the blade extends out of the blade recess to cut the magnetic adhesive tape. The ring extends from the distal end of the base, is mounted around the retaining post and has a curved gap and a straight gap. The curved gap is defined between the ring and the retaining post. The straight gap is defined between the ring and the opening and has a free end extending beyond the distal end of the blade.

The curved gap allows the ring of the blade base to selectively press the retaining post to press the free end of the ring against the magnetic adhesive tape and securely hold the magnetic adhesive tape. Consequently, the dispenser can be held with one hand and pivoted at the opening to have the blade cut the magnetic adhesive tape, which makes use of the dispenser more convenient and efficient.

Additionally, because the free end of the ring of the blade base extends beyond the distal end of the blade, a person's fingers are protected from being injured by the blade to improve safety during use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a dispenser for magnetic adhesive tape in accordance with the present invention;

FIG. 2 is an exploded perspective view of the dispenser in FIG. 1;

FIG. 3 is a side view of the dispenser in FIG. 1 with the left shell being removed;

FIG. 4 is an enlarged operational side view of the dispenser in FIG. 3 with magnetic adhesive tape being drawn out of the dispenser;

FIG. 5 is an operational side view of the dispenser in FIG. 4 with the dispenser being pivoted to cut the magnetic adhesive tape;

FIG. 6 is a perspective view of an object attached to a bulletin board with magnetic adhesive tape;

FIG. 7 is an enlarged operational rear view in partial section of the dispenser in FIG. 2 with a sliding connecting tab to connect the left and right shells to each other; and

FIG. 8 is an enlarged cross-sectional bottom view of the dispenser in FIG. 1 with a hook and a recess formed respectively in the right and left shells to combine the left and the shells with each other.

### DETAILED DESCRIPTION OF THE PREFERRED EMBODIMENT

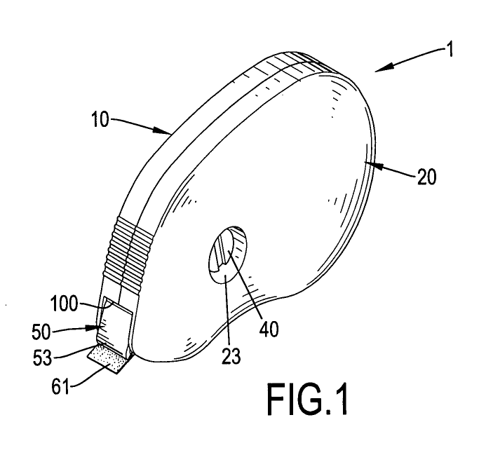

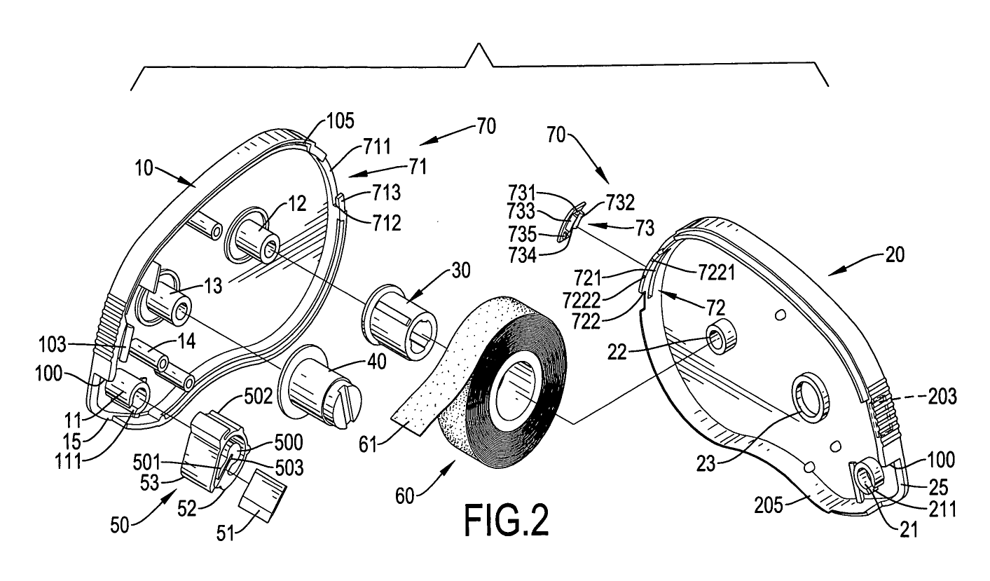

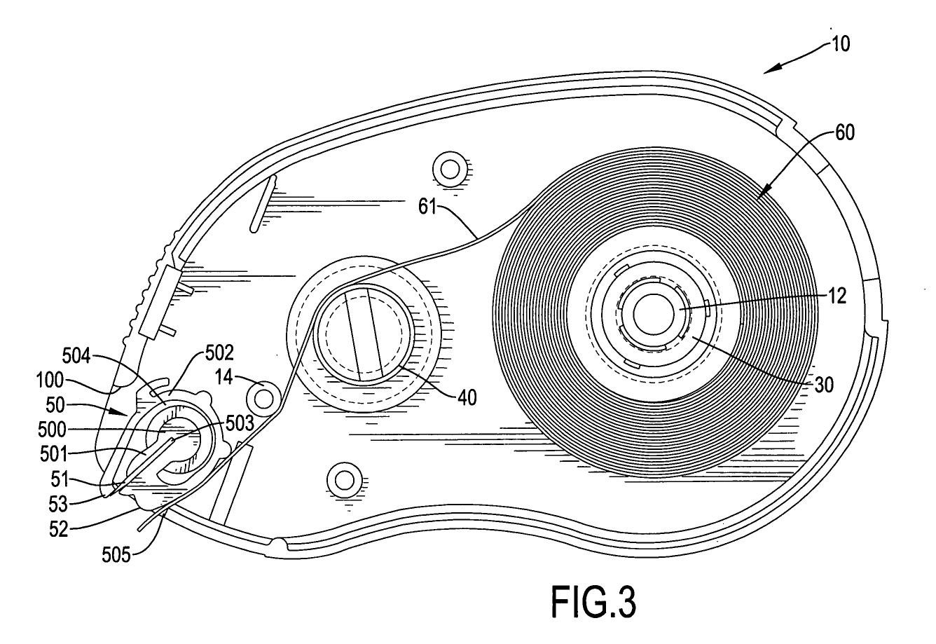

With reference to FIGS. 1 to 3, a dispenser for magnetic adhesive tape in accordance with the present invention comprises a housing (1), an optional rolling bushing (30), an optional rolling barrel (40) and a blade base (50).

The housing (1) is hollow and has an inner surface, an outer surface, a front, a rear, a bottom, a mounting post (12), an opening (100), an optional primary guidepost (13), an optional secondary guidepost (14), a retaining post (11) and may be implemented with a right shell (10), a left shell (20) and an optional latch assembly (70).

The mounting post (12) is formed on and protrudes perpendicularly from the inner surface of the housing (1) to rotatably hold a roll of magnetic adhesive tape roll (60).

The opening (100) is formed through the housing (1) at the front and bottom of the edge of the housing (1) to allow a free end of magnetic adhesive tape (61) on the roll of magnetic adhesive tape (60) to extend from the housing.

The primary guidepost (13) is formed on and protrudes perpendicularly from the inner surface of the housing (1) between the mounting post (12) and the opening (100) to guide the free end of the magnetic adhesive tape (61).

The secondary guidepost (14) is formed on and protrudes perpendicularly from the inner surface of the housing (1) between the primary guidepost (13) and the opening (100) to guide the free end of the magnetic adhesive tape (61).

The retaining post (11) is tubular, is formed on and protrudes perpendicularly from the inner surface of the housing (1) near the opening (100) and has a longitudinal slot (111).

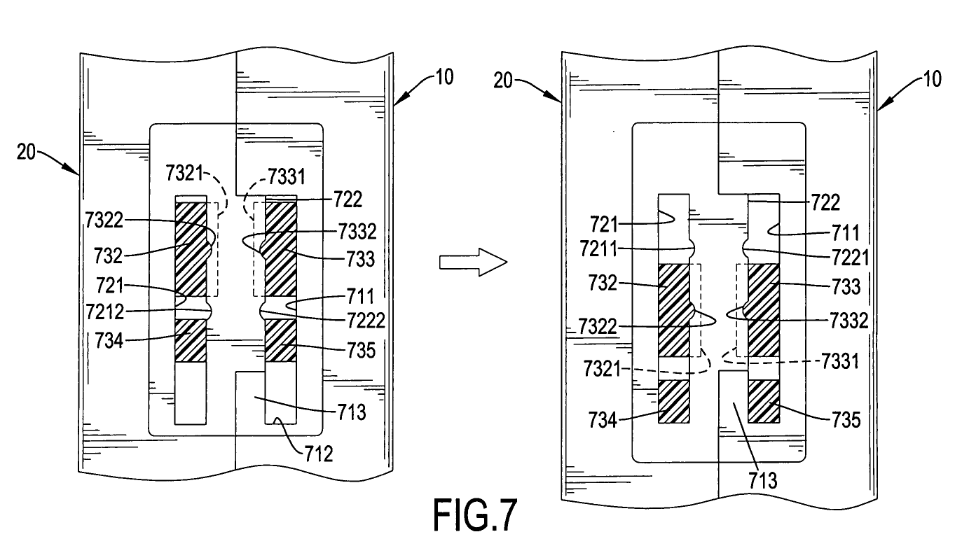

The right shell (10) has an inner surface, an outer edge, an outer surface and a flange. The inner surface is part of the inner surface of the housing (1) on which the mounting post (12), the primary guidepost (13), the secondary guidepost (14) and the retaining post (11) are formed. The outer surface is part of the outer surface of the housing (1). With further reference to FIG. 7, the flange is formed on and protrudes perpendicularly in from the outer edge of the right shell (10) and has an inner surface, an outer surface, a distal edge, a right pass notch (15), an optional recess (105) and an optional hook (103).

The right pass notch (15) is formed in the flange of the right shell (10) and is part of the opening (100) in the housing (1).

The recess (105) is formed in the inner surface of the flange of the right shell (10) and communicates with the distal edge of the flange of the right shell (10).

The hook (103) is formed on and protrudes from the inner surface of the flange of the right shell (10).

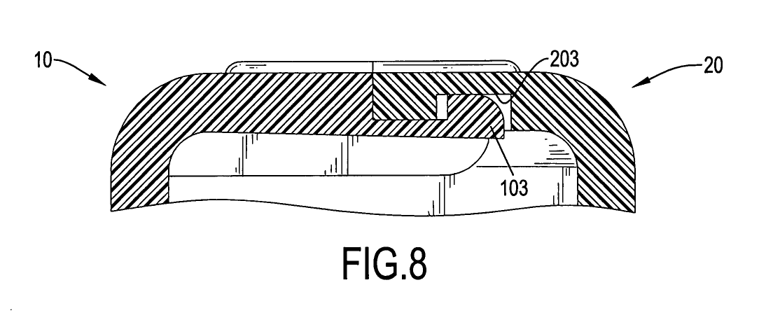

The left shell (20) is connected to the right shell (10) and has an inner surface, an outer edge, an outer surface, a flange, an optional connecting post (22), an optional connecting hole (23) and an optional connecting retaining post (21). The inner surface is part of the inner surface of the housing (1). The outer surface is part of the outer surface of the housing (1). With further reference to FIG. 8, the flange is formed on and protrudes perpendicularly in from the outer edge of the left shell (20), corresponds and connects to the flange on the right shell (10) and has an inner surface, an outer surface, a distal edge, a left pass notch (25), an optional lip (205) and an optional connecting recess (203).

The left pass notch (25) is formed in the flange of the left shell (20) and corresponds to the right pass notch (15) to form the opening (100) in the housing (1).

The lip (205) is formed on the inner surface of the flange of the left shell (20) at the distal edge of the flange of the left shell (20), corresponds to and is mounted in the recess (105) in the flange of the right shell (10).

The connecting recess (203) is formed in the inner surface of the flange of the left shell (20), corresponds to and securely holds the hook (103) to securely connect the left shell (20) to the right shell (10).

The connecting rod (22) is formed on and protrudes perpendicularly from the inner surface of the left shell (20) and aligns with and connects to the mounting post (12) on the right shell (10).

The connecting hole (23) is formed through the left shell (20), aligns with the primary guidepost (13) and has an optional annular lip. The annular lip is formed around the connecting hole (23) and protrudes from the inner surface of the left shell (20).

The connecting retaining post (21) is formed on and protrudes perpendicularly from the inner surface of the left shell (20), aligns with and connects to the retaining post (11) and has a longitudinal slot (211). The longitudinal slot (211) aligns with the longitudinal slot (111) in the retaining post (11) on the right shell (10).

The latch assembly (70) connects the left shell (20) detachably to the right shell (10) and has a latch groove (71), a latch bracket (72) and a connecting tab (73).

The latch groove (71) is formed in the flange on the left shell (10) at the rear of the housing (1), has an outer surface and may be implemented with a recess (711), a locking slot (712) and a latch tab (713). The outer surface corresponds to the outer surface of the flange of the right shell (10).

The recess (711) is formed in the distal edge of the flange and has an outer opening, an inner edge and a lower edge. The inner edge is parallel to the distal edge of the flange of the right shell (10).

The locking slot (712) is parallel to the distal edge of the flange of the right shell (10), is flush with the inner edge of the recess (711), communicates with the lower edge of the recess (711) and has a lower end.

The latch tab (713) is adjacent to the locking slot (712) and the recess (711) and is flush with the distal edge of the flange of the right shell (10).

The latch bracket (72) is formed on the flange on the right shell (20) at the rear of the housing (1), has an outer surface and may be implemented with a mounting slot (721) and a protrusion (722). The outer surface of the latch bracket (72) corresponds to the outer surface of the flange of the left shell (20).

The mounting slot (721) is parallel to the inner edge of the recess (711) in the latch groove (71) and has an upper end, a lower end, a distal edge, an open detent (7211) and a closed detent (7212).

The lower end corresponds to the lower end of the locking slot (712).

The open detent (7211) is formed in the distal edge of the mounting slot (721) near the upper end of the mounting slot (721).

The closed detent (7212) is formed in the distal edge of the mounting slot (721) near the open detent (7211) but toward the lower end of the mounting slot (721).

The protrusion (722) is mounted detachably in the recess (711) in the latch groove (71), forms a slot in the recess (711) and has a distal edge, an open detent (7221) and a closed detent (7222).

The slot is formed in line and communicates with the locking slot (712).

The open detent (7221) is formed in the distal edge of the protrusion (722) and corresponds to the open detent (7211) in the mounting slot (721).

The closed detent (7222) is formed in the distal edge of the protrusion (722) and corresponds to the closed detent (7212) in the mounting slot (721).

The connecting tab (73) is a captive fastener, is mounted slidably on the outer surfaces of the latch bracket (72) and the latch groove (71), slidably in the latch bracket (72) and detachably in the latch groove (71), has an open position and a closed position and may be implemented with a thumb tab (731), a left rail (732), a right rail (733), a left locking latch (734) and a right locking latch (735).

The thumb tab (731) is mounted slidably on the outer surfaces of the latch bracket (72) and the latch groove (71) and has a bottom.

The left rail (732) is formed longitudinally on and protrudes down from the bottom of the thumb tab (731), is mounted slidably in the mounting slot (721) in the latch bracket (72) and has a distal edge, an inside surface, an upper end, a lip (7321) and a boss (7322).

The upper end corresponds to the upper end of the mounting slot (721) when the connecting tab (73) is in the open position.

The lip (7321) holds the left rail (732) in the mounting slot (721) and is formed on and protrudes transversely in from the distal edge of the left rail (732).

The boss (7322) is formed on and protrudes from the inside surface of the left rail (732), engages the open detent (7211) in the mounting slot (721) when the connecting tab (73) is in the open position and engages the closed detent (7212) in the mounting slot (721) when the connecting tab (73) is in the closed position.

The right rail (733) is formed longitudinally on and protrudes down from the bottom of the thumb tab (731), is mounted slidably against the distal edge of the protrusion (722) of the latch bracket (72) and has a distal edge, an inside surface, an upper end, a lip (7331) and a boss (7332).

The upper end corresponds to the upper end of the protrusion (722) when the connecting tab (73) is in the open position.

The lip (7331) holds the right rail (733) in position relative to the protrusion (722) and is formed on and protrudes transversely in from the distal edge of the right rail (733).

The boss (7332) is formed on and protrudes from the inside surface of the right rail (733), engages the open detent (7221) in the protrusion (722) when the connecting tab (73) is in the open position and engages the closed detent (7222) in the protrusion (722) when the connecting tab (73) is in the closed position.

The left locking latch (734) is formed longitudinally on and protrudes down from the bottom of the thumb tab (731) in line with the left rail (732) and is mounted slidably in the mounting slot (721) in the latch bracket (72).

The right locking latch (735) is formed longitudinally on and protrudes down from the bottom of the thumb tab (731) in line with the right rail (733) and is mounted slidably in the slot in the latch groove (71) when the protrusion (722) is mounted in the recess (711) and the connecting tab (73) is in the open position and in the locking slot (712) when the connecting tab (73) is in the closed position. When the right locking latch (735) is in the locking slot (712), the right locking latch (735) abuts the latch tab (713) to hold the right shell (10) securely against the left shell (20).

The rolling bushing (30) is mounted securely in a roll of magnetic adhesive tape (60) and rotatably around the mounting post (12) to allow the roll of magnetic adhesive tape (60) to be mounted rotatably around the mounting post (12).

The rolling barrel (40) is mounted rotatably around the primary guidepost (13) for contact with an adhesive side of the magnetic adhesive tape (61) to achieve smooth movement of free end of the magnetic adhesive tape (61) and has a distal end. The distal end may extend through the connecting hole (23) in the left shell (20) so a user can press a finger against the distal end to hold the roll of magnetic adhesive tape (60) when cutting the free end of the magnetic adhesive tape (61).

The blade base (50) is mounted on the retaining post (11) and has a base (500), a blade (51) and a ring (502).

The base (500) is mounted securely on the retaining post (11) and has a distal end (501) and a blade recess (503). The distal end (501) of the base (500) extends radially out of the longitudinal slot (111) in the retaining post (11). The blade recess (503) is formed in the distal end (501) of the base (500).

The blade (51) is mounted in the blade recess (503) and has a distal edge extending out of the blade recess (503) to cut the free end of the magnetic adhesive tape (61).

The ring (502) extends from the distal end (501) of the base (500), is mounted around the retaining post (11) and has a curved gap (504), a straight gap (505), a foot (52) and a free end (53).

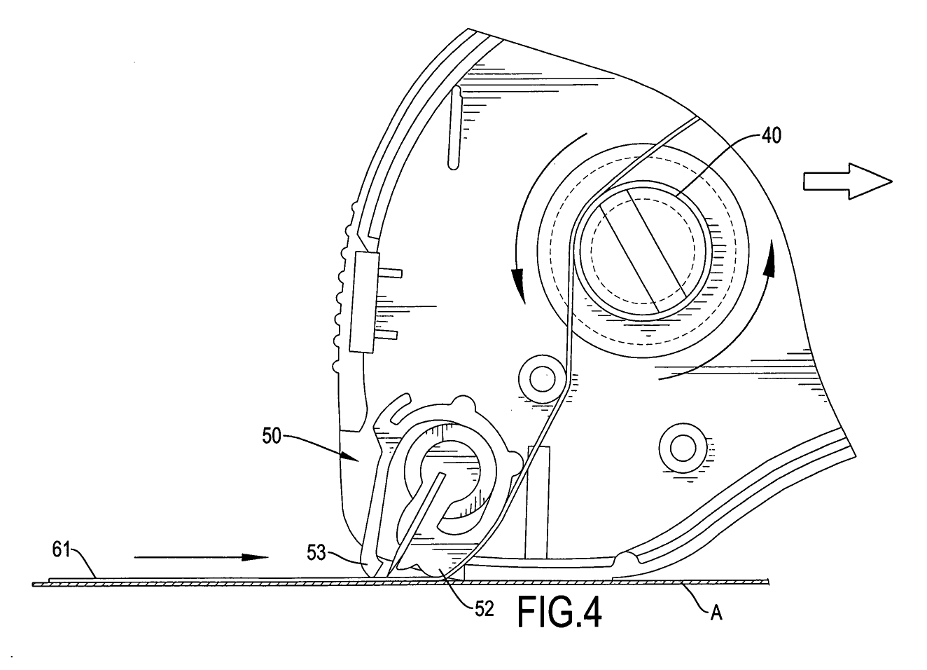

With further reference to FIG. 4, the curved gap (504) is defined between the ring (502) and the retaining post (11), allows resilient movement for the ring (502) to selectively press against the retaining post (11).

The straight gap (505) is defined between the ring (502) and the opening (100), allows the magnetic adhesive tape (61) to pass through.

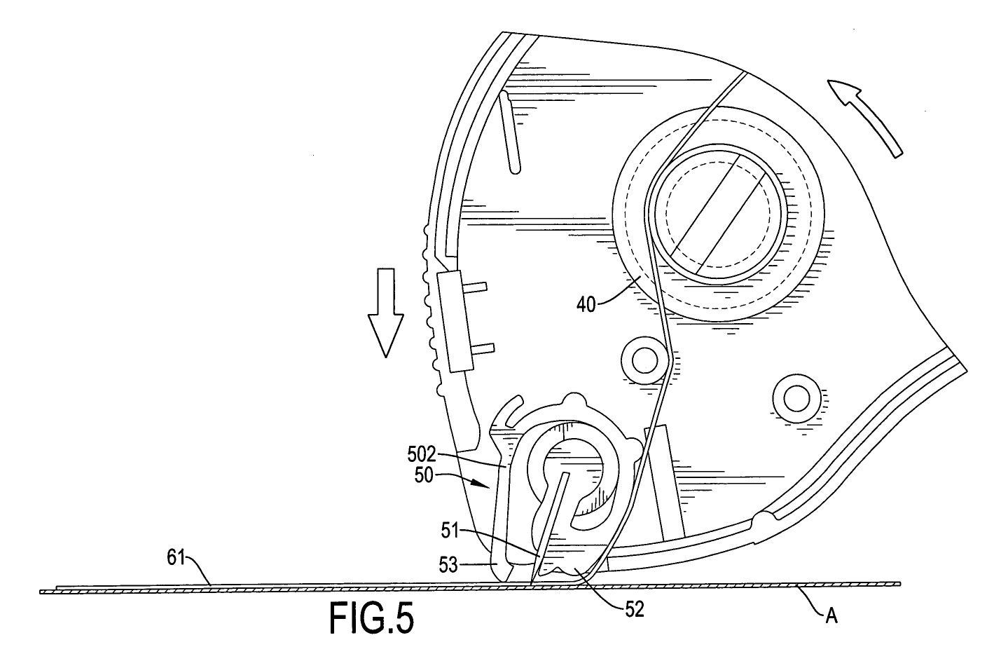

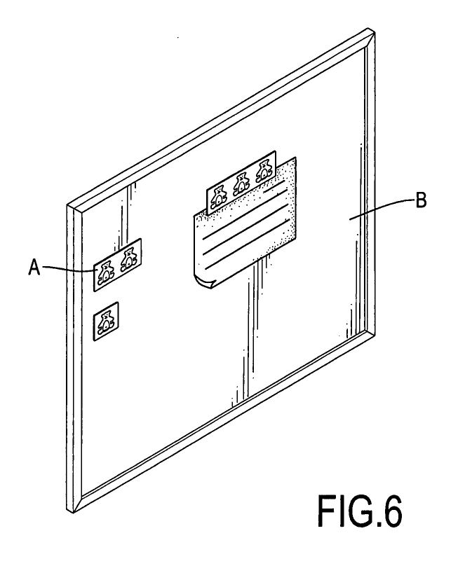

With further reference to FIGS. 4 to 6, the foot (52) is formed near the opening (100) and has a curved surface. The surface presses the magnetic adhesive tape (61) tightly against a surface of an object (A).

The free end (53) extends beyond the distal end of the blade (51) to prevent a person from inadvertently being injured by the blade (51).

When a desired length of magnetic adhesive tape (61) is pulled out and pressed on the object (A), the free end (53) of the ring portion (502) can be pressed against the magnetic adhesive tape (61), and then the dispenser can be pivoted at the free end (53) to move the distal end of the blade (51) to cut the free end of the magnetic adhesive tape (61) to a desired length.

After the free end of the magnetic adhesive tape (61) is cut and bonded to an object (A) such as a greeting card or the like, the object (A) can be attached to any magnetic surface (B) such as a bulletin board, a refrigerator or the like.

Holding and handling the dispenser with one hand is convenient, so fingers of a user are prevented from being contaminated by the adhesive on the magnetic adhesive tape (61). Additionally, the distal end of the blade (51) is sheltered by the free end (53) of the ring portion (502) of the blade base (50), so a person's fingers are prevented from being injured by the blade (51), and safety during use is greatly improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A dispenser for magnetic adhesive tape comprising
a housing being hollow and having
an inner surface;
an outer surface;
a front;
a rear;
a bottom;
a mounting post being formed on and protruding perpendicularly from the inner surface of the housing;
an opening being formed through the housing at the front and bottom of the housing; and
a retaining post being tubular, being formed on and protruding perpendicularly from the inner surface of the housing near the opening and having a longitudinal slot; and
a blade base being mounted on the retaining post and having
a base mounted securely on the retaining post and having
a distal end extending radially out of the longitudinal slot in the retaining post; and
a blade recess formed in the distal end of the base;
a blade being mounted in the blade recess and having a distal end extending out of the blade recess; and
a ring extending from the distal end of the base, being mounted around the retaining post and having
a curved gap defined between the ring and the retaining post;
a straight gap defined between the ring and the opening;
and a free end extending beyond the distal end of the blade.

2. The dispenser as claimed in claim 1, wherein
the ring of the blade base further has a foot formed near the opening; and
the foot has a curved surface.

3. The dispenser as claimed in claim 1, wherein the housing is implemented with a right shell and a left shell.

4. The dispenser as claimed in claim 1, wherein
the housing further has a primary guidepost formed on and protruding perpendicularly from the inner surface of the housing between the mounting post and the opening; and
the dispenser further has a rolling barrel mounted rotatably around the primary guidepost and having a distal end.

5. The dispenser as claimed in claim 4, wherein the housing further has a secondary guidepost formed on and protruding perpendicularly from the inner surface of the housing between the primary guidepost and the opening.

6. The dispenser as claimed in claim 5, wherein the housing is implemented with
a right shell having
an inner surface being part of the inner surface of the housing on which the mounting post, the primary guidepost, the secondary guidepost and the retaining post are formed;
an outer edge;
an outer surface being part of the outer surface of the housing; and
a flange formed on and protruding perpendicularly in from the outer edge of the right shell and having
an inner surface;
an outer surface;
a distal edge; and
a right pass notch formed in the flange of the right shell and being part of the opening in the housing; and
a left shell having
an inner surface being part of the inner surface of the housing;
an outer edge;
an outer surface being part of the outer surface of the housing; and
a flange formed on and protruding perpendicularly in from the outer edge of the left shell, corresponding and connecting to the flange on the right shell and having
an inner surface;
an outer surface;
a distal edge; and
a left pass notch formed in the flange of the left shell and corresponding to the right pass notch and to form the opening in the housing.

7. The dispenser as claimed in claim 6, wherein
the flange of the right shell further has
a recess formed in the inner surface of the flange of the right shell and communicating with the distal edge of the flange of the right shell;
the flange of the left shell further has
a lip formed on the inner surface of the flange of the left shell at the distal edge of the flange of the left shell, corresponding to and mounted in the recess in the flange of the right shell; and
the housing further has a latch assembly connecting the left shell detachably to the right shell and having
a latch groove formed in the flange on the left shell at the rear of the housing and having an outer surface that corresponds to the outer surface of the flange of the right shell;
a latch bracket being formed in the flange on the right shell at the rear of the housing and having an outer surface corresponding to the outer surface of the flange of the left shell; and
a connecting tab being a captive fastener, being mounted slidably on the outer surfaces of the latch bracket and the latch groove, slidably in the latch bracket and detachably in the latch groove and having an open position and a closed position.

8. The dispenser as claimed in claim 7, wherein
the flange of the right shell further has a hook formed on and protruding from the inner surface of the flange of the right shell; and
the flange of the left shell further has a connecting recess formed in the inner surface of the flange of the left shell and corresponding to and securely holding the hook to securely connect the left shell to the right shell.

9. The dispenser as claimed in claim 4, wherein
the housing is implemented with
a right shell; and
a left shell connected to the right shell to form the housing and having
an inner surface; and
a connecting hole formed through the inner surface of the left shell and aligning with the primary guidepost; and
the distal end of the rolling barrel extends through the connecting hole in the left shell.

10. The dispenser as claimed in claim 1, wherein the dispenser further has a roll bushing mounted rotatably around the mounting post.

11. The dispenser as claimed in claim 7, wherein
the latch groove is implemented with
a recess formed in the distal edge of the flange and having
an outer opening;
an inner edge being parallel to the distal edge of the flange of the right shell; and
a lower edge;
a locking slot being parallel to the distal edge of the flange of the right shell, being flush with the inner edge of the recess, communicating with the lower edge of the recess and having a lower end; and
a latch tab being adjacent to the locking slot and the recess and being flush with the distal edge of the flange of the right shell;
the latch bracket is implemented with
a mounting slot being parallel to the inner edge of the recess in the latch groove and having
an upper end;
a lower end corresponding to the lower end of the locking slot;
a distal edge;
an open detent formed in the distal edge of the mounting slot near the upper end of the mounting slot; and
a closed detent formed in the distal edge of the mounting slot near the open detent but toward the lower end of the mounting slot; and
a protrusion being mounted detachably in the recess in the latch groove, forming a slot in line and communicating with the locking slot in the recess and having
a distal edge;
an open detent being formed in the distal edge of the protrusion and corresponding to the open detent in the mounting slot; and
a closed detent being formed in the distal edge of the protrusion and corresponding to the closed detent in the mounting slot;
the connecting tab is implemented with
a thumb tab mounted slidably on the outer surfaces of the latch bracket and the latch groove and having a bottom;
a left rail being formed longitudinally on and protruding down from the bottom of the thumb tab, being mounted slidably in the mounting slot in the latch bracket and having
a distal edge;
an inside surface;
an upper end corresponding to the upper end of the mounting slot when the connecting tab is in the open position;
a lip holding the left rail in the mounting slot and being formed on and protruding transversely in from the distal edge of the left rail; and
a boss being formed on and protruding from the inside surface of the left rail, engaging the open detent in the mounting slot when the connecting tab is in the open position and engaging the closed detent in the mounting slot when the connecting tab is in the closed position;
a right rail being formed longitudinally on and protruding down from the bottom of the thumb tab, being mounted slidably against the distal edge of the protrusion of the latch bracket and having
a distal edge;
an inside surface;
an upper end corresponding to the upper end of the protrusion when the connecting tab is in the open position;
a lip holding the right rail in position relative to the protrusion and being formed on and protruding transversely in from the distal edge of the right rail; and
a boss being formed on and protruding from the inside surface of the left rail, engaging the open detent in the protrusion when the connecting tab is in the open position and engaging the closed detent in the protrusion when the connecting tab is in the closed position;
a left locking latch being formed longitudinally on and protruding down from the bottom of the thumb tab in line with the left rail and being mounted slidably in the mounting slot in the latch bracket; and
a right locking latch being formed longitudinally on and protruding down from the bottom of the thumb tab in line with the right rail and being mounted slidably in the slot in the latch groove when the protrusion is mounted in the recess and the connecting tab is in the open position and in the locking slot when the connecting tab is in the closed position.
